(19) United States
(12) Patent Application Publication
(10) Pub. No.: US 2005/0021412 A1
(43) Pub. Date: Jan. 27, 2005

(54) Prepaid internet card

(76) Inventor: Joseph Michael Wilson, Fallbrook, CA (US)

Correspondence Address: Joseph M. Wilson, 857 Hamilton Lane, Fallbrook, CA, 92028, US

(21) Appl. No.: 10/436,475

(22) Filed: Jul. 23, 2003

(51) Int. Cl. G06F 17/60

(52) U.S. Cl. 705/26

(57) ABSTRACT

In accordance with the present invention of a prepaid Internet card for on-line purchasing comprising the use of a current method of payment, the financial debit/charge card system, in a new way, with same physical characteristics (i.e. financial debit/charge card) and electronic mechanisms (i.e. pin numbers, monetary transfers) of a financial debit/charge card system so that consumer can complete a Internet on-line purchase transaction. The purpose of using the financial debit/charge card system is to enable a consumer to purchase a prepaid Internet card at a value set by the consumer. The card is used on the same established transaction lines as Visa, MasterCard, American Express and Discover. This prepaid card protects a consumer's identity and financial information due to the nature of the card itself being a prepaid card.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of the Invention

This invention relates to prepaid cards, specifically for on-line Internet on line purchasing.

2. Background of the Invention

The most common way to make Internet on-line purchases is by credit card. This method of payment have some inherent problems. First, being the exposure of identity theft and financial fraud through unsecured Internet lines to on-line criminals. The second, a consumer base unable to obtain credit cards has never had the ability to shop on the Internet. Lastly, those individuals who have the ability to purchase on-line by credit card but are afraid to, due to fear of identity and financial thefts.

So, how do Internet consumers limit risk of financial and identity theft? How does a consumer without credit lines shop on the World Wide Web? And since the credit card industry controls the common way of payment on the Internet how can a new method financial payment be introduced within the system and increase the Internet economic market at the same time.

The solution is a prepaid method that works as a financial debit/charge card. In other words, a consumer simply purchases a prepaid Internet card with a value determined by the cash amount applied to the card upon purchase. Since the card is not credit bound no need for the consumer to impart pertinent information regarding their identity or financial background. Also, this prepaid card allows for cash carrying consumers to enter the Internet goods and services market. For those who have Internet theft and fraud fears this prepaid Internet card shields them from on-line criminals as well In addition, by using the financial debit/charge card system as method for payment over the Internet, the prepaid Internet card is user friendly to the monetary transaction end of the World Wide Web.

This simple prepaid Internet card solution creates identity and fraud protection and opens the economic door to a whole new consumer market without having to build a new monetary transfer structure in order to complete the purchase transaction on the World Wide Web.

### BACKGROUND OF THE INVENTION—INTENTIONS

A) To create a method of payment for Internet on-line purchases without exposing the consumer's identity.

B) To create a method of payment for Internet on-fine purchases without exposing the consumer's financials.

C) Create a method of payment for Internet on-line purchases that allows cash consumers to now interact with World Wide Web.

D) Use a financial debit/charge card system as the conduit in order to complete the Internet on-line purchase transaction.

### SUMMARY

In accordance with the present invention a prepaid Internet card for on-line purchasing comprises of using a current method for payment, the financial debit/charge card system, in a new way, with all the same physical tools (i.e. financial debit/charge card) and electronic mechanisms (i.e. pin numbers, monetary transfers) of a financial debit/charge card system so that a consumer can complete a Internet on-line purchase transaction. The exception is that the consumer obtain such a prepaid card without having to expose his/her identity or financials nor have a credit background. The prepaid Internet card for on-line purchasing has a monetary value established by the cash or credit card amount applied to the prepaid card by the consumer.

1. A method of on-line Internet purchasing with a prepaid debit card comprising:
A) Using the financial debit/charge card system, including the same physical tools (i.e. financial debit/charge card) and electronic mechanisms (i.e. pin numbers, monetary transfers) of a dial debit/charge card to complete a debit/charge card purchase and/or transaction.
B) Providing consumers a financial debit/charge card to be used for on-line Internet purchasing.
C) Establishing the value of the prepaid Internet debit/charge card is determined by the consumer at time of purchase.
D) Working the same as a financial debit/charge card, the prepaid Internet card has the ability to complete financial transactions on the Internet with the same electronic line transfer as Visa, MasterCard, Discover or American Express.
E) Making a purchase, the consumer simply enters the card number with a corresponding Pin number and the transaction is treated as the same as Visa, MasterCard, Discover or American Express charge or debit card.
F) Purchasing can only be made as long as the prepaid value of the card does not exceed the amount deposited in whole or part with card.
